(19) United States
(12) Patent Application Publication
(10) Pub. No.: US 2011/0257285 A1
(43) Pub. Date: Oct. 20, 2011

(54) EPOXIDE-BASED STRUCTURAL FOAM HAVING IMPROVED TENACITY

(75) Inventors: Emilie Barriau, Duesseldorf (DE); Olaf Lammerschop, Danville, CA (US); Thomas Engels, Duesseldorf (DE); Xaver Muenz, Heidelberg (DE)

(73) Assignee: Henkel AG & Co., KGaA, Duesseldorf (DE)

(21) Appl. No.: 13/095,282

(22) Filed: Apr. 27, 2011

Related U.S. Application Data
(63) Continuation of application No. PCT/EP2009/062310, filed on Sep. 23, 2009.

(30) Foreign Application Priority Data
Oct. 28, 2008 (DE) 10 2008 053 518.4

(51) Int. Cl. C08L 75/04

(52) U.S. Cl. 521/156

(57) ABSTRACT

Disclosed is a thermally expandable and curable material containing:

a) at least one epoxide prepolymer;
b) at least one heat-activated curing agent for the prepolymer;
c) at least one foaming agent;
d) at least one thermoplastic polyurethane or isocyanate;
e) at least one block copolymer.

Said thermally expandable and curable material can be used for stiffening or reinforcing components.

This application is a continuation under 35 U.S.C. Section 365(c) and 120 of International Application No. PCT/EP2009/062310, filed Sep. 23, 2009 and published on May 6, 2010 as WO 2010/049220, which claims priority from German Patent Application No. 10 2008 053 518.4 filed Oct. 28, 2008, which are incorporated herein by reference in their entirety.

### FIELD OF THE INVENTION

The present invention relates to foamable and curable epoxy resin mixtures, which may be used in foamed and cured states as structural foams for reinforcing hollow metal structures in particular. The compounds contain a combination of thermoplastic polyurethanes and block copolymers, leading to an optimized profile of properties with regard to processability in the uncured state and mechanical properties after curing.

### BACKGROUND OF THE INVENTION

Lightweight parts for series production that constantly maintain their dimensions and have a high stiffness and structural strength are needed for many fields of applications. Because of the desired weight savings in automotive engineering in particular, there is a high demand for lightweight parts made of structures having thin walls but adequate stiffness and structural strength nevertheless. One way to achieve a high stiffness and structural strength with the lowest possible weight of the component uses hollow parts manufactured from relatively thin plate metal or plastic sheeting. However, thin plate metal has a tendency to deform easily. It has therefore been known already for some time that the cavities of hollow body structures may be filled with structural foam, thereby preventing or minimizing deformation on the one hand while increasing the strength and stiffness of these parts on the other hand.

Such foamed reinforcing and stiffening agents are usually metal foams or contain a thermally curable resin or binder, e.g., epoxy resins. These compositions usually contain a blowing agent, fillers and reinforcing fillers, e.g., hollow microbeads of glass. Such foams preferably have a density of 0.3 to 0.7 g/cm³ in the foamed and cured state. After curing, these foams should be able to withstand temperatures higher than 130° C., preferably higher than 150° C., at least briefly without being damaged. Such foamable, thermally curable compositions usually contain other components, such as curing agents, process aids, stabilizers, dyes or pigments, optionally UV absorbers and adhesion promoting constituents.

WO 96/37400 describes a W-shaped reinforcing structure, which contains a thermally expandable resin-type material and is introduced prior to curing into the hollow body to be reinforced. The polymeric matrix to be reinforced preferably consists of a single-component system of a pasty consistency, containing an epoxy resin, an acrylonitrile-butadiene rubber, fillers, high-strength glass beads, a curing agent as well as an accelerator and a blowing agent based on an azo compound or a hydrazide compound.

WO 00/27920 discloses expandable sealing and damping compositions, which are mixtures of a thermoplastic resin and/or a plurality of thermoplastic resins and an epoxy resin. These should be injection moldable and should have a light weight and a high compressive strength. Examples of thermoplastic resins that may be mentioned include solid rubbers, such as styrene-butadiene rubbers and nitrile-butadiene rubbers or polystyrene polymers, for example, SBS block copolymers. The epoxy resin is preferably liquid.

WO 01/92415 discloses thermally curable compounds, which have an improved impact strength and contain block copolymers with methyl methacrylate. Particles having a core-shell structure may also be present. However, the materials disclosed here do not contain any blowing agent, i.e., they are not optimized for use as a structural foam.

German Patent Application DE 102006048739 describes binders for production of expandable, thermally curable molded bodies, containing:

at least one epoxy resin,
at least one polyester that is solid at room temperature,
at least one blowing agent,
at least one curing agent and
at least one filler.

In addition, “flexibilizing agents” may also be present. For example, solid rubbers may be mentioned as flexibilizing agents. Examples of suitable solid rubbers include polybutadiene, styrene-butadiene rubber, butadiene-acrylonitrile rubber, EPDM, synthetic or natural isoprene rubber, butyl rubber or polyurethane rubber. Partially crosslinked solid rubbers based on isoprene-acrylonitrile or butadiene-acrylonitrile copolymers are especially suitable.

WO 2007/004184 describes a thermally foamable material containing the following components:
a) a solid epoxy resin, which is essentially free of liquid or semisolid epoxy resin,
b) an impact improver,
c) a curing agent and
d) a heat-activatable blowing agent.

The impact improver may be a thermoplastic material. Examples mentioned include: epoxy-polyurethane hybrids and isocyanate prepolymers (for example, isocyanate-terminated polyether polyols) having a molecular weight in the range between 1000 and 10,000 g/mol. In addition, a number of block copolymers are mentioned as impact improvers. These may have a core-shell structure.

WO 2007/025007 discloses a composition having the following components:
a) at least one epoxy resin,
b) rubber particles having a core-shell structure,
c) another impact modifier or toughness improver and
d) a heat-activatable latent curing agent.

In addition, the composition may also contain blowing agents, so that it can be used as a structural foam. For example, polyurethanes derived from hydroxyl-terminated polyoxyalkylenes, such as polypropylene glycol or polytetrahydrofurandiol are mentioned as component c). Instead of or in addition, block copolymers may also be present, for example, those in which at least one polymer block has a glass transition temperature below 20° C. (preferably below 0° C. or below −30° C. or below −50° C.), for example, a polybutadiene block or a polyisoprene block. At least one additional block of the block copolymer has a glass transition temperature above 20° C. (preferably above 50° C. or above 70° C.), for example, a polystyrene block or a polymethyl methacrylate block. Specific examples that can be mentioned include: styrene-butadiene-methyl methacrylate block copolymers, methyl methacrylate-butadiene-methyl methacrylate block copolymers and butadiene-methyl methacrylate block copolymers.

Three-dimensional parts of structural foams are usually produced today by the injection molding method. Because of the tackiness of these materials at temperatures above 30° C., the starting material cannot be used in granular form for production of parts by the injection molding method. To nevertheless be able to produce parts by this method, the material feed to the injection molding machine must be modified in an expensive operation. A special feed is necessary and thus it is impossible for production of parts to be performed on conventional commercial injection molding machines.

If formulations having a higher melting point are used to increase the softening point to approximately 40° C., the structural foam part in the injection molding machine must be processed at higher temperatures to fill the molds. Temperatures above 100° C. are not allowed because otherwise the curing reaction of the composition is triggered, possibly leading to blockage of the machine.

Due to the high viscosity at temperatures just above the melting point of the epoxy resins and especially due to the tackiness of the liquefied epoxy resins, the production of injection-molded parts is possible only in a very poor manner and with substantial technical complexity. This usually requires special equipment on the processing machines and thus increases investment costs.

Due to the internal tackiness of the molten casting compound, the flow behavior in the injection molding machine and the injection molds is greatly exacerbated. The tackiness of the hot injection molding compound based on epoxy resins may lead to soiling of the systems, therefore greatly increasing the maintenance and cleaning costs. Release agents may be used to remedy this situation, but these can cause corrosion on molds and machines, which in turn increases the need for maintenance.

### SUMMARY OF THE INVENTION

The object of the present invention is to make available injection molding compounds based on epoxy resins, in which the problems mentioned above do not occur at all or occur to a greatly reduced extent. At the same time, the mechanical properties of the cured material should be improved even at temperatures <0° C., in particular the compression resistance, compression strength, compression failure and modulus.

### DETAILED DESCRIPTION OF THE INVENTION

The present invention relates to a thermally expandable and curable compound containing:

a) at least one epoxy prepolymer,
b) at least one heat-activatable curing agent for the prepolymer,
c) at least one blowing agent,
d) at least one thermoplastic polyurethane or isocyanate,
e) at least one block copolymer.

In addition, the material may contain as a component:

f) rubber particles.
These contribute toward improving the impact strength of the cured material, especially at temperature below 0° C. These rubber particles preferably have a core-shell structure.

It is preferable for the rubber particles that have a core-shell structure to have a core made of a polymer material with a glass transition temperature lower than 0° C. and a shell of a polymer material having a glass transition temperature higher than 25° C. Especially suitable rubber particles having a core-shell structure may have a core made of a diene homopolymer and a diene copolymer or a polysiloxane elastomer and/or a shell made of an alkyl(meth)acrylate homopolymer or copolymer.

The core of these core-shell particles may be, for example, a diene homopolymer or copolymer, which may be selected from a homopolymer of butadiene or isoprene, a copolymer of butadiene or isoprene with one or more ethylenically unsaturated monomers, for example, vinyl aromatic monomers, (meth)acrylonitrile, (meth)acrylates or similar monomers. The polymer or copolymer of the shell may contain as the monomer, for example: (meth)acrylates such as in particular methyl methacrylate, vinyl aromatic monomers (for example, styrene), vinyl cyanides (for example, acrylonitrile), unsaturated acids or anhydrides (for example, acrylic acid), (meth)acrylamides and similar monomers, which lead to polymers having a suitable high glass transition temperature.

The polymer or copolymer of the shell may have acid groups which may crosslink by forming metal carboxylate, for example, by forming a salt with divalent metal cations. In addition, the polymer or copolymer of the shell may be covalently crosslinked by using monomers having two or more double bonds per molecule.

Other rubber-type polymers, for example, polybutyl acrylate or polysiloxane elastomers, such as polydimethylsiloxane, for example, in particular crosslinked polydimethylsiloxane, may be used as the core.

These core-shell particles typically have a structure such that the core constitutes 50 to 95 wt % of the core-shell particle and the shell constitutes 5 to 50 wt % of this particle.

These rubber particles are preferably relatively small. For example, the average particle size (which can be determined by light scatter methods, for example) may be in the range from approximately 0.03 μm to approximately 2 μm, in particular in the range from approximately 0.05 μm to approximately 1 μm. However, smaller core-shell particles may also be used, for example, those whose average diameter is smaller than approximately 500 nm, especially smaller than approximately 200 nm. For example, the average particle size may be in the range of approximately 25 nm to approximately 200 nm.

Production of such core-shell particles is known in the prior art, as indicated in WO 2007/025007, for example, on page 6, lines 16 to 21. Commercial order sources for such core-shell particles are listed in the last paragraph on page 6 to the first paragraph on page 7 of this document. Reference is herewith made to these order sources. In addition, reference is made to production processes for such particles, which are described in the aforementioned document on page 7, paragraph 2 to page 8, paragraph 1. For further details concerning suitable core-shell particles, reference is also made to the aforementioned document WO 2007/025007, where detailed information in this regard can be found on page 8, line 15 to page 13, line 15.

Inorganic particles having a shell of organic polymers may assume the same function as the rubber particles mentioned above having a core-shell structure. Another preferred embodiment of the present invention is therefore characterized in that the material according to the invention contains as an additional component:

g) inorganic particles
having a shell of organic polymers.

In this embodiment, the material according to the invention preferably contains inorganic particles having a shell of organic polymers, such that the organic polymers are selected from homopolymers or copolymers of acrylic acid esters and/or methacrylic acid esters and at least 30 wt % acrylic acid esters and/or methacrylic acid esters polymerized into them.

The acrylic acid esters and/or methacrylic acid esters are preferably methyl and/or ethyl esters, at least a portion of the esters especially preferably being in the form of methyl ester. In addition, the polymers may also contain unesterified acrylic acid and/or methacrylic acid, which can improve the binding of the organic polymers to the surface of the inorganic particles. Therefore, in this case it is especially preferable if the monomer units of unesterified acrylic and/or methacrylic acid are situated (close) to the end of the polymer chain that binds to the surface of the inorganic particles.

It is preferable for the organic polymers to consist of at least 80 wt % acrylic acid esters and/or methacrylic acid esters. In particular they may consist of 90 wt %, 95 wt % or completely thereof. If the organic polymers contain monomers other than these acrylic acid esters and/or methacrylic acid esters and/or unesterified acrylic acid and/or methacrylic acid, they are preferably selected from comonomers containing epoxy, hydroxyl and/or carboxyl groups.

The organic polymers of the shell are preferably uncrosslinked or they are so weakly crosslinked that no more than 5% monomer units of a chain are crosslinked with monomer units of another chain. It may be advantageous for the polymers near the surface of the inorganic particles to be more strongly crosslinked than those farther outward in the shell. In particular the shell preferably has a structure such that at least 80%, in particular at least 90% and especially preferably at least 95% of the polymer chains are bound at one end to the surface of the inorganic particles.

The inorganic particles preferably have an average particle size in the range of 1 to 1000 nm, in particular in the range of 5 to 30 nm, before applying the shell of organic polymers. It is known that the particle size can be determined by light scatter methods as well as by electron microscopy.

The shell of organic polymers has a lower density than the inorganic particles themselves. The shell of organic polymers preferably has a thickness such that the weight ratio of inorganic core to the shell of organic polymers is in the range of 2:1 to 1:5, preferably in the range of 3:2 to 1:3. This can be controlled through the choice of reaction conditions in the growth of the shell of organic polymer onto the inorganic particles.

In general, the inorganic particles may be selected from metals, oxides, hydroxide, carbonate, sulfates and phosphates. Mixed forms of oxides, hydroxides and carbonates, for example, basic carbonates or basic oxides may also be used. If inorganic particles of metals are selected, then preferably iron, cobalt, nickel or alloys containing at least 50 wt % of one of these metals are used. Oxides, hydroxides or mixed forms thereof are preferably selected from those of silicon, cerium, cobalt, chromium, nickel, zinc, titanium, iron, yttrium, zirconium and/or aluminum. Mixed forms thereof are also possible, for example, particles of aluminosilicates or silicatic glasses. Especially preferred are zinc oxide, aluminum oxides or hydroxides as well as SiO₂ and/or the oxide forms of silicon known as “silicic acid” or “silica” in English. In addition, the inorganic particles may consist of carbonates, for example, calcium carbonate, or sulfates, for example, barium sulfate. It is of course also possible for particles having inorganic cores of various compositions to be present side-by-side.

To produce the inorganic particles having a shell of organic polymers, one may proceed, for example, as described in WO 2004/111136 A1 on the example of the coverage of zinc oxide with alkylene ether carboxylic acids. According to this procedure, the untreated inorganic particles are suspended in an apolar or slightly polar solvent, then monomeric or prepolymeric components of the shell are added, the solvent is removed and the polymerization is initiated, for example, as a free radical or photochemical polymerization. In addition, it is possible to proceed as in the production process described in EP 1 469 020 A1, where monomers or prepolymers of the shell material are used as the organic coating component for the particles. In addition, production of the coated particles by “atom transfer radical polymerization” is also possible as described for polymerization of n-butyl acrylate on silicic nanoparticles, for example, in: G. Carrot, S. Diamanti, M. Manuszak, B. Charleux, J.-P. Vairon: “Atom Transfer Radical Polymerization of n-Butyl Acrylate from Silica Nanoparticles”, J. Polym. Sci., Part A: Polymer Chemistry, vol. 39, 4294-4301 (2001).

In addition, it is also possible to rely on production processes such as those described in WO 2006/053640. For the present invention, inorganic cores such as those described with their production process in WO 2006/053640 from page 5, line 24 to page 7, line 15 are to be selected. These cores are coated as described in this document from page 10, line 22 to page 15, line 7. It is also possible to follow the proposal of this document (page 15, lines 9 to 24) to subject the inorganic cores to a pretreatment before polymerizing the sheath onto the core. The following passage appears at the site referenced:

“In particular when using inorganic cores, it may also be preferable, before polymerization of the jacket, for the core to be subjected to a pretreatment which allows binding of the jacket. This may usually consist of a chemical functionalization of the particle surface such as that known from the literature for a wide variety of inorganic materials. It may be preferable in particular to apply such chemical functions to the surface which allow grafting of the jacket polymers as reactive chain ends. Terminal double bonds, epoxy functions and polycondensable groups can be mentioned here as examples in particular. The functionalization of surfaces having hydroxyl groups with polymers is known from EP-A-337 144, for example.”

The epoxy prepolymers, which are also referred to below as “epoxy resins,” may be fundamentally saturated, unsaturated, cyclic or acyclic, aliphatic, alicyclic, aromatic or heterocyclic polyepoxy compounds.

Suitable epoxy resins as part of the present invention include, for example, those preferably selected from epoxy resins of the bisphenol A type, epoxy resins of the bisphenol S type, epoxy resins of the bisphenol F type, epoxy resins of the phenol-novolac type, epoxy resins of the cresol-novolac type, epoxidized products of dicyclopentadiene-modified phenolic resins obtainable by reaction of dicyclopentadiene with numerous phenols, epoxidized products of 2,2′,6,6′-tetramethylbiphenol, aromatic epoxy resins such as epoxy resins with a naphthalene basic structure and epoxy resins with a fluorene basic structure, aliphatic epoxy resins such as neopentyl glycol diglycidyl ether and 1,6-hexanediol diglycidyl ether, alicyclic epoxy resins, such as 3,4-epoxycyclohexylmethyl-3,4-epoxycyclohexane carboxylate and bis(3,4-epoxycyclohexyl) adipate and epoxy resins with a hetero ring, such as triglycidyl isocyanurate. The epoxy resins include in particular the reaction product of bisphenol A and epichlorohydrin, the reaction product of phenol and formaldehyde (novolac resins) and epichlorohydrin, glycidyl esters as well as the reaction product of epichlorohydrin and p-aminophenol, for example.

Additional polyphenols that yield suitable epoxy resin prepolymers by reaction with epichlorohydrin (or epibromohydrin) include resorcinol, 1,2-dihydroxy-benzene, hydroquinone, bis(4-hydroxyphenyl)-1,1-isobutane, 4,4′-di-hydroxybenzophenone, bis(4-hydroxyphenyl)-1,1-ethane and 1,5-hydroxynaphthalene.

Other suitable epoxy prepolymers include polyglycidyl ethers of polyalcohols or diamines. Such polyglycidyl ethers are derived from polyalcohols, for example, ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other preferred epoxy resins that are commercially available include in particular octadecylene oxide, epichlorohydrin, styrene oxide, vinylcyclohexene oxide, glycidol, glycidyl methacrylate, diglycidyl ethers of bisphenol A (e.g., those available under the brand names Epon 828, Epon 825, Epon 1004 and Epon 1010 from Hexion Specialty Chemicals Inc., DER-331, DER-332, DER-334, DER-732 and DER-736 from Dow Chemical Co.), vinylcyclohexene dioxide, 3,4-epoxycyclohexylmethyl-3,4-epoxycyclohexene carboxylate, 3,4-epoxy-6-methylcyclohexylmethyl-3,4-epoxy-6-methylcyclohexene carboxylate, bis(3,4-epoxy-6-methylcyclohexylmethyl) adipate, bis(2,3-epoxycyclopentyl)ether, aliphatic epoxy modified with polypropylene glycol, dipentene dioxide, epoxidized polybutadiene (e.g., Krasol products from Sartomer), epoxide functionality-containing silicone resin, flame-retardant epoxy resins (e.g., DER-580, a brominated epoxy resin of the bisphenol type obtainable from Dow Chemical Co.), 1,4-butanediol diglycidyl ether of a phenol-formaldehyde-novolac (e.g., DEN 431 and DEN 438 from Dow Chemical Co.), as well as resorcinol diglycidyl ether (e.g., Kopoxite from Koppers Company Inc.), bis(3,4-epoxycyclohexyl) adipate, 2-(3,4-epoxycyclohexyl-5,5-spiro-3,4-epoxy)-cyclohexane metadioxane, vinylcyclohexene monoxide, 1,2-epoxyhexadecane, alkyl glycidyl ethers, such as C₈-C₁₀ alkyl glycidyl ethers (e.g., Heloxy Modifier 7 from Hexion Specialty Chemicals Inc.), C₁₂-C₁₄ alkyl glycidyl ethers (e.g., Heloxy Modifier 8 from Hexion Specialty Chemicals Inc.), butyl glycidyl ether (e.g., Heloxy Modifier 61 from Hexion Specialty Chemicals Inc.), cresyl glycidyl ether (e.g., Heloxy Modifier 62 from Hexion Specialty Chemicals Inc.), p-tert-butylphenyl glycidyl ether (e.g., Heloxy Modifier 65 from Hexion Specialty Chemicals Inc.), polyfunctional glycidyl ethers, e.g., diglycidyl ethers of 1,4-butanediol (e.g., Heloxy Modifier 67 from Hexion Specialty Chemicals Inc.), diglycidyl ethers of neopentyl glycol (e.g., Heloxy Modifier from Hexion Specialty Chemicals Inc.), diglycidyl ethers of cyclohexanedimethanol (e.g., Heloxy Modifier 107 from Hexion Specialty Chemicals Inc.), trimethylolethane triglycidyl ether (e.g., Heloxy Modifier 44 from Hexion Specialty Chemicals Inc.), trimethylolpropane triglycidyl ether (e.g., Heloxy Modifier 48 from Hexion Specialty Chemicals Inc.), polyglycidyl ether of an aliphatic polyol (e.g., Heloxy Modifier 84 from Hexion Specialty Chemicals Inc.), polyglycol diepoxide (e.g., Heloxy Modifier 32 from Hexion Specialty Chemicals Inc.), bisphenol F epoxide (e.g., EPN-1138 or GY-281 from Huntsman Int. LLC), 9,9-bis-4-(2,3-epoxy-propoxy)phenylfluorenone (e.g., Epon 1079 from Hexion Specialty Chemicals Inc.).

Additional preferred, commercially available compounds are selected, for example, from Araldite™ 6010, Araldit™ GY-281, Araldit™ ECN-1273, Araldit™ ECN-1280, Araldit™ MY-720, RD-2 from Huntsman Int. LLC; DEN™ 432, DEN™ 438, DEN™ 485 from Dow Chemical Co., Epon™ 812, 826, 830, 834, 836, 71, 872, 1001, 1031, etc., from Hexion Specialty Chemicals Inc. and HPT™ 1071, HPT™ 1079, also from Hexion Specialty Chemicals Inc., also as novolac resins, for example, Epi-Rez™ 5132 from Hexion Specialty Chemicals Inc., ESCN-001 from Sumitomo Chemical, Quatrex 5010 from Dow Chemical Co., RE 305S from Nippon Kayaku, Epiclon™ N673 from DaiNippon Ink Chemistry or Epicote™ 152 from Hexion Specialty Chemicals Inc.

In addition, the following polyepoxides may also be used at least proportionally: polyglycidyl esters of polycarboxylic acids, for example, reaction products of glycidol or epichlorohydrin with aliphatic or aromatic polycarboxylic acids, such as oxalic acid, succinic acid, glutaric acid, terephthalic acid or dimer fatty acid.

The epoxy equivalent of suitable polyepoxides may vary between 150 and 50,000, preferably between 170 and 5000. For example, an epoxy resin based on epichlorohydrin-bisphenol A, having an epoxy equivalent weight of 475 to 550 g/eq and/or an epoxy group content in the range of 1820 to 2110 mmol/g is suitable. The softening point determined according to RPM 108-C is in the range of 75 to 85° C.

The thermally expandable and curable compound may contain at least one epoxy prepolymer a), which is liquid at room temperature (22° C.). This facilitates processing of the compound by injection molding. The presence of an epoxy prepolymer that is liquid at room temperature usually leads to an unwanted tackiness, but this is reduced by the thermoplastic polyurethane d), which is present according to the invention, to such an extent that the compound can readily be processed by the injection molding process.

Reaction products of epichlorohydrin with bisphenol A or bisphenol F are preferably used as such epoxy prepolymers that are liquid at room temperature. These prepolymers typically have epoxy equivalent weights in the range of approximately 150 to approximately 480.

Thermally activatable or latent curing agents for the epoxy resin-binder system are used as the curing agents. They may be selected from the following compounds: guanidines, substituted guanidines, substituted ureas, melamine resins, guanamines derivatives, cyclic tertiary amines, aromatic amines and/or mixtures thereof. The curing agents may be incorporated stoichiometrically into the curing reaction, but they may also be catalytically active. Examples of substituted guanidines include methylguanidine, dimethylguanidine, trimethylguanidine, tetramethylguanidine, methyl isobiguanidine, dimethylisobiguanidine, tetramethyl isobiguanidine, hexamethyl isobiguanidine, hepamethyl isobiguanidine and most especially cyanoguanidine (dicyanodiamide). Representatives of suitable guanamines derivatives include alkylated benzoguanamine resins, benzoguanamine resins or methoxymethylethoxymethylbenzoguanamine. Dicyanodiamide is especially preferred.

In addition to or instead of the aforementioned curing agents, catalytically active substituted ureas may also be used. These include in particular p-chlorophenyl-N,N-dimethylurea (Monuron), 3-phenyl-1,1-dimethylurea (Fenuron) or 3,4-dichlorphenyl-N,N-dimethylurea (Diuron). In principle, catalytically active tertiary acrylamines or alkylamines, for example, benzyldimethylamine, tris(dimethylamino)phenol, piperidine or piperidine derivatives may also be used. In addition, various imidazole derivatives, preferably those that are solid, may be used as catalytically active accelerators. Representative examples include 2-ethyl-2-methylimidazole, N-butylimidazole, benzimidazole as well as N—C₁ to C₁₂ alkylimidazoles or N-arylimidazoles. In addition, adducts of amino compounds onto epoxy resins are also suitable as accelerating additives to the aforementioned curing agents. Suitable amino compounds include tertiary aliphatic, aromatic or cyclic amines. Suitable epoxy compounds include, for example, polyepoxides based on glycidyl ethers of bisphenol A or F or resorcinol. Specific examples of such adducts include adducts of tertiary amines such as 2-dimethylaminoethanol, N-substituted piperazine, N-substituted homopiperazines, N-substituted aminophenols onto di- or polyglycidyl ethers of bisphenol A or F or resorcinol.

In principle, any known blowing agents, for example, the “chemical blowing agents,” which release gases through decomposition, or “physical blowing agents,” i.e., expanding hollow beads, are suitable as the blowing agents. Examples of the former type of blowing agent include azobisisobutyronitrile, azodicarbonamide, dinitrosopentamethylenetetramine, 4,4′-oxybis(benzenesulfonic acid hydrazide), diphenylsulfone-3,3′-disulfohydrazide, benzene-1,3disulfohydrazide, p-toluene-sulfonyl semicarbazide. The expandable hollow plastic microbeads based on polyvinylidene chloride copolymers or acrylonitrile-(meth)acrylate copolymers are especially preferred. These are available commercially, for example, under the brand names Dualite® and Expancel® from the companies Pierce & Stevens and Casco Nobel.

The amount of blowing agent is preferably selected so that the volume of the compound increases irreversibly by at least 10%, preferably at feast 20% and in particular at least 50% on heating to an activation temperature (or expansion temperature). This is to be understood as meaning that in addition to the normal and reversible thermal expansion, the volume of the material is irreversibly increased in comparison with the starting volume at room temperature (22° C.) when heated to the activation temperature so that it is at least 10%, preferably at least 20% and in particular at least 50% larger after cooling back to room temperature. The stated degree of expansion is thus based on the volume of the compound at room temperature before and after being heated temporarily to the activation temperature. The upper limit of the degree of expansion, i.e., the irreversible increase in volume, can be adjusted through the choice of the amount of blowing agent, so that it is less than 300%, in particular less than 200%.

The activation temperature is preferably in the range of 120 to 220° C. This temperature should preferably be maintained for a period of time in the range of 10 to 150 minutes.

The material according to the invention contains a thermoplastic polyurethane or isocyanate as component d). The term “thermoplastic polyurethane” is often abbreviated as TPU; this is a term familiar to those skilled in the art in the field in question here. A TPU is an at least essentially linear polymer which is formed by the polymerization reaction of three starting components:
1. a diisocyanate,
2. a short-chain diol (often referred to as a “chain extender”) of the general formula (OH—R—OH), where R stands for a hydrocarbon radical having 1 to 4 carbon atoms,
3. a long-chain dial (OH—Z—OH), where the Z group stands for polymer chain which leads to a so-called soft segment of the resulting polyurethane. For example, the group Z may constitute a polyether or polyester chain. Polyether chains may be formed by ring-opening polymerization of alkylene oxides, for example, ethylene oxide or propylene oxide, or by a corresponding reaction of saturated heterocycles containing oxygen, for example, tetrahydrofuran. Polyester chains are formed by reaction of divalent alcohols with dibasic carboxylic acids. A preferred polyester chain consists of polycaprolactone polyester.

A polyurethane containing soft segments and hard segments in alternation is obtained in the reaction of these three components. The soft segments are formed by the Z group. The hard segments are formed from the diisocyanate and the short-chain diol.

The polarity of the hard segments leads to a strong attraction between them, which in turn leads to a high degree of aggregation and order in the solid phase of the polymer. Thus crystalline or pseudocrystalline regions, which are embedded in the soft and flexible matrix of the soft segments, are formed. The crystalline and pseudocrystalline regions of the hard segments act as a physical linkage, which imparts a high elasticity to the TPU. The flexible chains of the soft segments contribute toward the elongation behavior of the polymer.

The thermoplastic polyurethane or isocyanate d) is preferably selected from such polyurethanes, which contain a polyester chain and do not have any reactive groups, in particular no isocyanate groups.

Thermoplastic polyurethanes, which are solid at room temperature (22° C.) and have a glass transition temperature below −20° C., preferably below −30° C., are preferred. In addition, the thermoplastic polyurethane d), which is preferably solid at room temperature, has a melting range or a softening range according to Kofler which begins above 100° C., preferably above 115° C.

Suitable polyurethanes d) that are preferably solid at room temperature are characterized in addition by the fact that they have an elongation at break of at least 300%, preferably at least 400% as the pure substance.

The number-average molecular weight of suitable polyurethanes d), which can be determined by gel permeation chromatography, is preferably in the range of 40,000 g/mol to 120,000 g/mol, in particular in the range of 50,000 g/mol to 90,000 g/mol.

Polyester-based thermoplastic polyurethanes having the properties mentioned above are suitable in particular for producing the desired low tackiness of the materials according to the invention on the one hand and their simpler processing by injection molding, while on the other hand ensuring the required mechanical stability of the cured material. Compounds having an E modulus of at least 900 MPa in the cured state and having a compression resistance of at least 15 MPa are considered to be suitable, whereas compounds having values below that are regarded as being less suitable for the intended purpose. The compression failure, i.e., the deformability under pressure until failure, should be at least 20%.

In particular, thermoplastic polyurethanes d) containing a polycaprolactone polyester chain are suitable as the thermoplastic polyurethanes d) having the aforementioned properties.

Suitable thermoplastic polyurethanes that meet the aforementioned criteria are available commercially and can be ordered from Merquinsa in Spain, for example, or Danquinsa GmbH in Germany on the basis of these specifications.

According to the invention, the compound contains as additional component e) at least one block copolymer. This is preferably selected from those having a first polymer block with a glass transition temperature of less than 15° C., in particular less than 0° C., and a second polymer block with a glass transition temperature higher than 25° C. in particular higher than 50° C. In addition, suitable block copolymers are those selected from the ones in which a first polymer block is selected from a polybutadiene block or a polyisoprene block and a second polymer block is selected from a polystyrene block or a polymethyl methacrylate block.

For example, the block copolymer (e) is selected from copolymers having the following block structure: styrene-butadiene-(meth)acrylate, styrene-butadiene-(meth)acrylic acid ester, ethylene-(meth)acrylic acid ester-glycidyl(meth)acrylic acid ester, ethylene-(meth)acrylic acid ester-maleic acid anhydride, (meth)acrylic acid ester-butyl acrylate-(meth)acrylic acid ester, preferably methyl methacrylate-butyl acrylate-methyl methacrylate.

The block copolymers listed above correspond to those that may also be used within the scope of the WO 2007/025007 cited initially. Details in this regard and additional block copolymers that are suitable within the scope of the present invention can be found in this document on page 25, line 21 to page 26, line 9. Cross-references to documents in which the production of such block copolymer is described will also be found there.

The composition of these block copolymers is defined above by the fact that the monomer unit for each block is indicated. This is understood to mean that each block copolymer contains polymer blocks of the specific monomers mentioned. In the individual polymer blocks, up to 20 mol % of the aforementioned monomers can be replaced by other comonomers. This is true of blocks of polymethyl methacrylate in particular.

The aforementioned block copolymers improve the impact strength of the cured materials according to the invention, in particular at temperatures above 0° C.

As a rule, the substance mixtures that may be used according to the invention also contain essentially known fillers, for example, the various ground or precipitated chalks, carbon black, calcium-magnesium carbonates, talc, heavy spar and in particular silicate fillers of the aluminum-magnesium-calcium silicate type, e.g., wollastonite, chlorite. Fillers containing mica may also be used here, a so-called two-component filler of muscovite mica and quartz having a low heavy metal content being most especially preferred.

For weight reduction, the substance mixture also may contain so-called lightweight fillers in addition to the “normal” fillers mentioned above. These may be selected from the group of hollow metal beads, e.g., hollow steel beads, hollow glass beads, fly ash (Fillite), hollow plastic beads based on phenolic resins, epoxy resins or polyesters, expanded hollow microbeads with a wall material from (meth)acrylic acid ester copolymers, polystyrene, styrene-(meth)acrylate copolymers as well as in particular from polyvinylidene chloride and the copolymers of vinylidene chloride with acrylonitrile and/or (meth)acrylic acid esters, hollow ceramic beads or lightweight organic fillers of natural origin such as ground nut shells, for example, cashew nut shells, coconut shells or peanut shells as well as cork meal or cork powder. Such lightweight fillers based on hollow microbeads which ensure a high compressive strength of the molded body in the cured molded body matrix are especially preferred.

In an especially preferred embodiment, the thermally curable compounds additionally contain fibers, for example, based on aramid fibers, carbon fibers, metal fibers—e.g., from aluminum—glass fibers, polyamide fibers, polyethylene fibers or polyester fibers, where these fibers are preferably pulp fibers or staple fibers having a fiber length between 0.5 and 6 mm and a diameter of 5 to 20 μm. Polyamide fibers of the aramid fiber type or polyester fibers are especially preferred here.

In addition, the curable compounds according to the invention may contain other auxiliary agents and additives, e.g., plasticizers, rheology aids, wetting agents, adhesion mediators, antiaging agents, stabilizers and/or colored pigments. The quantity ratios of the individual components may vary in relatively wide limits, depending on the profile of requirements with respect to the processing properties, flexibility, required reinforcing effect or the tackifying bond to the substrates.

The intended compounds may optionally contain reactive diluents for adjusting the flow behavior. Reactive diluents in the sense of this invention are epoxy group-containing low-viscosity substances (glycidyl ethers or glycidyl esters) having an aliphatic or aromatic structure. Typical examples of reactive diluents include mono-, di- or triglycidyl ethers of C₆ to C₁₄ monoalcohols or alkyl phenols as well as the monoglycidyl ethers of cashew nut shell oil, diglycidyl ethers of ethylene glycol, diethylene glycol, triethylene glycol, tetraethylene glycol, propylene glycol, dipropylene glycol, tripropylene glycol, tetrapropylene glycol, 1,4-butylene glycol, 1,5-pentanediol, 1,6-hexanediol, cyclohexanedimethanol, triglycidyl ethers of trimethylolpropane as well as the glycidyl esters of C₆ to C₂₄ carboxylic acids or mixtures thereof.

Typical ranges for the essential components are as follows, given in wt %, based on the total material:
a) epoxy prepolymer: 10% to 65%, preferably 20% to 60%,
b) heat-activatable curing agent for the prepolymer: 1% to 10%, preferably 2% to 8%,
c) blowing agent: 0.5% to 10%, preferably 1% to 5%,
d) thermoplastic polyurethane or isocyanate: 1% to 50%, preferably 5% to 35%, in particular 10% to 20%,
e) block copolymer: 1-50%, preferably 5% to 30%,
f) rubber particles: 0 to 40%, preferably at least 5% and at most 25%,
g) inorganic particles having a shell of organic polymers: 0-40%, preferably at least 5% and at most 25%,
h) fillers: 0-50%, preferably at least 5% and at most 30%,
   where the sum of the total components yields 100 wt %.

The compositions according to the invention can easily be produced in the form of granules and thus can easily be stored temporarily and shipped in traditional containers, big bags, drums or sacks. They can be processed further in conventional injection molding systems without requiring special storage, metering and conveying equipment. The structural foams that can be produced from these compositions have good properties in compressive or bending loads comparable to those of the epoxy-based compositions known in the past.

The compositions according to the invention surprisingly do not exhibit any runoff or leaching in the cleaning and pretreatment baths at 65° C. under simultaneous flow loads despite the good flow behavior in the injection molding machine in the process of manufacturing the body shell in automotive production. Furthermore, there is no discernible tackiness of the molded bodies or granules at temperature below 45° C.

Thermally expandable molded bodies, which can be used for stiffening and/or reinforcement of metal components, are preferably produced from the expandable thermally curable compositions by the injection molding process at low pressures and low temperatures.

For example, the substance mixture may be extruded through a die with the help of an extruder at a temperature in the range of 50° C. to 100° C. and then cut into pieces after being cooled to a temperature below 50° C. Molded bodies whose shape is adapted to that of the cavity to be reinforced can be produced by extrusion through a suitably shaped die and cutting to the desired length. This yields, for example, a molded body of a reactive crosslinking compound that is expandable by at least 20% at a temperature in the range of 120° C. to 220° C.

As an alternative to this, a method for producing molded bodies from a substance mixture as described above is selected, such that the substance mixture is introduced into an injection mold at a temperature in the range of 50° C. to 100° C. with the help of an extruder and then is unmolded after being cooled to a temperature below 50° C.

For the extrusion, it is possible to start with a substance mixture, which is fed as a premixed but unmolded material into the extruder or which is first mixed in the extruder itself from the individual raw materials. However, it is also possible to use the substance mixture in the form of the granules described above. The granules are melted before being fed into the extruder or they are preferably melted in the extruder itself and then are pressed into the injection mold in this state.

This process variant is characterized by the following essential process steps:
a) Mixing the components of the composition described above at temperatures below 100° C., preferably between 80 and 95° C.;
b) Extrusion of the composition at temperatures below 100° C., preferably 80° C. to 95° C., forming granules, optionally onto a cooled metal sheet;
c) Cooling the granules shaped in this way;
d) Optional temporary storage of the granules, preferably in containers, big bags, drums or sacks;
e) Conveying the granules to an injection molding machine;
f) Melting the granules at temperatures below 100° C. and injecting the melt into the predetermined mold of the injection molding machine;
g) Cooling the molded body thereby formed and removing the molded body from the mold.

Due to the content of the thermoplastic polyurethane(s) or isocyanate d), the tackiness of the compound containing epoxy resin is reduced to the extent that no release agent need be used for the extrusion or injection molding process.

In addition, the present invention comprises an extruded or injection-molded body consisting of a thermally expandable and curable compound according to the preceding description.

The main application of the molded bodies according to the invention is for stiffening and reinforcing components, in particular components for household appliances or for automotive body parts such as body frames, doors, trunk lids, engine hoods and/or roof parts in automotive engineering. The present invention therefore also includes a vehicle or a metallic component stiffened or reinforced using at least one of the molded bodies described above, obtained by extrusion or injection molding.

The present invention comprises in particular a method for reinforcing, insulating, damping and/or sealing hollow components, such that a molded body obtained according to the invention is secured on an inside wall of the hollow component before completion of the hollow component, then the hollow component is closed and heated to a temperature in the range of 120° C. to 220° C., preferably for a period time in the range of 10 to 150 minutes.

The usual production processes for elongated hollow structures in automotive engineering are utilized for this process, for example, for the frame surrounding the passenger compartment. These hollow structures are usually manufactured by manufacturing two suitably shaped half-shells of metal and joining these half-shells to form the hollow frame structure and/or part thereof. Such hollow structures or hollow carriers include, for example, the A, B or C pillars of an automotive body, or they support the roof structure or they may also be roof rails, rocker panels as well as parts of the wheel wells or engine supports. As is customary when using so-called pillar filler or baffles in such hollow structures in the prior art, the molded bodies obtained according to the invention can then be attached with the help of a fastening element or a tacky surface section to the surface of one half-shell, which later becomes the inside wall of the cavity before this half-shell is joined to the other half-shell to form the hollow structure.

The molded body obtained according to the invention is preferably shaped so that its cross section, as seen at a right angle to the longitudinal axis, corresponds to the cross-sectional shape of the cavity. However, this molded body is of such dimensions that it is in contact with the inside wall of the hollow part at only one or a few locations before foaming. Apart from these locations, a flow gap with the width of approximately 1 mm to approximately 10 mm, preferably from approximately 2 mm to approximately 4 mm, remains between the bordering surfaces lying parallel to the longitudinal axis of the molded body and the inside walls of the hollow part. This flow gap ensures that the various process fluids with which the blank body is treated can wet all parts of the insides of the walls of the cavity. The flow gap is closed only with the thermal expansion of the molded body, so that it achieves its intended purpose of reinforcing, insulating, damping and/or sealing the hollow components. Spacers on the molded bodies can ensure that this flow gap is reliably formed before the foaming of the molded body and is preserved until foaming.

Exemplary embodiments (wt % based on the total composition):

| | | A | B | C | D |
|---|---|---|---|---|---|
| 1 | Epoxy resin, | 5% | 11.2% | 16% | 12% |
| | semisolid at 22° C. | | | | |
| 2 | Epoxy resin, | 10% | 28.2% | 18.8% | 20% |
| | solid at 22° C. | | | | |
| 3 | Epoxy resin, | 20% | 9.4% | — | — |
| | liquid at 22° C. | | | | |
| 4 | Core-shell particles | 15% | — | 18.8% | 20% |
| | (epoxy resin/butadiene- | | | | |
| | acrylic copolymer) | | | | |
| 5 | Block copolymer | 5% | 4.7% | 6.1% | 10% |
| | (polystyrene-polybutadiene- | | | | |
| | polymethyl methacrylate) | | | | |
| | (order source: AKEMA) | | | | |
| 6 | Thermoplastic | 10% | 4.7% | — | — |
| | polyurethane (TPU-1)* | | | | |
| 7 | Thermoplastic | — | — | 9.4% | 5% |
| | polyurethane (TPU-2)* | | | | |
| 8 | Calcium carbonate | 10.15% | 10% | 9.4% | 10% |
| 9 | Glass beads | 15% | 24.5% | 14.1% | 15% |
| 10 | Dicyanodiamide | 4.50% | 2.9% | 3.1% | 3.2% |
| 11 | Accelerator | 2.25% | 1.4% | 1.5% | 1.6% |
| | (Ajicure AH 300 a | | | | |
| | Fenuron derivative) | | | | |
| 12 | Physical blowing agent | 1.80% | 1.7% | 1.7% | 1.8% |
| | (Expancel 09 DU 140, | | | | |
| | Akzo Nobel) | | | | |
| 13 | Pyrolytic silica | 1% | 1% | 0.9% | 1% |
| 14 | Carbon black | 0.3% | 0.3% | 0.2% | 0.4% |
| | Total | 100% | 100% | 100% | 100% |

*TPU-1 = polyester-based polyurethane, number-average molecular weight 62,150 ± 100, melting range according to Kofler 155° C. to 165° C., tensile strength according to DIN 53,504: 35 MPa, elongation at break according to DIN 53,504: 420%, glass transition temperature (DSC 10° C. per minute): −22° C. TPU-2 = polyester-based polyurethane, melting range according to Kofler 135° C. to 145° C., tensile strength according to DIN 53,504: 30 MPa, elongation at break according to DIN 53,504: 500%, glass transition temperature (DSC 10° C. per minute): −27° C.

These components are mixed together in the following way: Components 6 and 7 were incorporated at 120° C. into components 1 through 5 that had been added first in a planetary mixer. Then the mixture was cooled to 80° C., components 8, 9, 13 and 14 were added and mixed for 30 minutes. Next, components 10 through 12 were added and mixed for 10 minutes. Finally, the mixture was evacuated for 5 minutes.

Injection-molded parts having little or no tackiness could be produced from the inventive mixtures using the following process parameters: temperature 20° C. to 80° C., dosing rate 15 m/min, backpressure 5 bar, dosing volume 8 cm³, injection pressure 350 bar.

After foaming and curing at 150° C., the compounds have the following properties:

| | A | B | C | D |
|---|---|---|---|---|
| Density before | 0.9 | 0.74 | 0.9 | 0.9 |
| curing (g/cm³) | | | | |
| Degree of | 89% | 97% | 54% | 78% |
| expansion (%) | | | | |
| Density after | 0.5 | 0.4 | 0.6 | 0.5 |
| curing (g/cm³) | | | | |
| Tensile shear | 3.9 | 3.8 | 1.8 | — |
| strength* (MPa) | | | | |
| Compressive | 25 | 15 | 18 | 20 |
| strength** (MPa) | | | | |
| Compression | 1070 | 900 | 915 | 660 |
| module** (MPa) | | | | |

*Tensile shear strength determined on oiled cold-rolled steel (1.5 mm), foam thickness 2 mm: 10 mm/min at room temperature
**Compressive strength and compression module, determined with cylinder (33 mm diameter and 66 mm length): 12 mm/min at room temperature.

1. A thermally expandable and curable compound, containing components:
a) at least one epoxide prepolymer,
b) at least one heat-activatable hardener for the prepolymer,
c) at least one blowing agent,
d) at least one thermoplastic polyurethane or isocyanate, and
e) at least one block copolymer.

2. The thermally expandable and curable compound according to claim 1, further comprising rubber particles.

3. The thermally expandable and curable compound according to claim 2, wherein the rubber particles have a core-shell structure.

4. The thermally expandable and curable compound according to claim 1, further comprising inorganic particles having a shell of organic polymers.

5. The thermally expandable and curable compound according to claim 1, wherein a thermoplastic non-reactive polyurethane selected from polyurethanes having a polyester chain is used as component d).

6. The thermally expandable and curable compound according to claim 5, wherein the thermoplastic non-reactive polyurethane is solid at 22° C. and has a glass transition temperature below −20° C.

7. The thermally expandable and curable compound according to claim 5, wherein the thermoplastic non-reactive polyurethane is solid at 22° C. and has a melting range or a softening range beginning above 100° C.

8. The thermally expandable and curable compound according to claim 5, wherein the thermoplastic non-reactive polyurethane is solid at 22° C. and, as a pure substance, has an elongation at break of at least 300%.

9. The thermally expandable and curable compound according to claim 5, wherein the thermoplastic non-reactive polyurethane has a number-average molecular weight in the range of 50,000 g/mol to 120,000 g/mol.

10. The thermally expandable and curable compound according to claim 1, wherein (e) is selected from block copolymers having a first polymer block with a glass transition temperature below 15° C. and a second polymer block with a glass transition temperature above 25° C.

11. The thermally expandable and curable compound according to claim 10, wherein (e) is selected from block copolymers in which a first polymer block is selected from a polybutadiene block or a polyisoprene block and a second polymer block is selected from a polystyrene block or a polymethyl methacrylate block.

12. The thermally expandable and curable compound according to claim 1, wherein the block copolymer (e) comprises block copolymers with a block structure selected from: styrene-butadiene-(meth)acrylate, styrene-butadiene-(meth)acrylic acid ester, ethylene-(meth)acrylic acid ester-glycidyl (meth)acrylic acid ester, ethylene-(meth)acrylic acid ester-maleic acid anhydride, methyl methacrylate-butyl acrylate-methyl methacrylate.

13. The thermally expandable and curable compound according to claim 1, further comprising one or more fillers selected from the group consisting of fibers, mineral fillers and light fillers.

14. The thermally expandable and curable compound according to claim 1, wherein said compound contains said components in quantity ranges, indicated in wt % based on the entire compound, of:
a) epoxide prepolymer: 10-65%,
b) heat-activatable hardener for the prepolymer: 1% to 10%,
c) blowing agent: 0.5% to 10%,
d) thermoplastic polyurethane or isocyanate: 1% to 50%,
e) block copolymer: 1-50%,
f) rubber particles: 0-40%,
g) inorganic particles having a shell of organic polymers: 0-40%,
h) fillers: 0-50%.

15. The thermally expandable and hardenable compound according to claim 14 wherein said compound contains said components in quantity ranges, indicated in wt % based on the entire compound, of:
a) epoxide prepolymer: 20-60%,
b) heat-activatable hardener for the prepolymer: 2% to 8%,
c) blowing agent: 1% to 5%,
d) thermoplastic polyurethane or isocyanate: 5% to 35%,
e) block copolymer: 5% to 30%,
f) rubber particles: at least 5% and at most 25%,
g) inorganic particles having a shell of organic polymers: at least 5% and at most 25%,
h) fillers: at least 5% and at most 30%.
